(19) United States
(12) Patent Application Publication
(10) Pub. No.: US 2002/0041094 A1
(43) Pub. Date: Apr. 11, 2002

(54) Insulating collar for quick release fittings

(76) Inventor: Stephen Twyman, Santa Rosa, CA (US)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 09/513,722

(22) Filed: Feb. 24, 2000

Related U.S. Application Data
(60) Provisional application No. 60/122,253, filed on Feb. 25, 1999.

(51) Int. Cl. F16L 11/12

(52) U.S. Cl. 285/45

(57) ABSTRACT

A thermally insulating collar device for use with metallic fittings such as quick release fittings where use with hot liquids or steam can cause the metallic fittings to become hot. The collar device is made from a thermally insulating material such as plastic, and is either formed over and around a fitting as manufactured, or designed as an aftermarket item to slip over an existing metallic fitting. Either embodiment enables manipulation of the movable portion of the quick release fitting in the traditional manner, while providing a thermally insulating layer of material over the metallic fitting to permit easy and comfortable actuation of the fitting, even when heated fluids are passing through the fitting.

### BACKGROUND OF THE INVENTION

1. Field of the Invention

This invention relates generally to pipe and hose fittings and associated hardware, and more specifically to an improved collar device for use with quick-release type hose fittings.

2. Description of Related Art

Quick release hose fittings are frequently used to enable fast and efficient connection and disconnection of pipes and hoses. For example, quick release fittings are routinely used in the carpet cleaning industry for connection of hoses to the cleaning equipment, and for connecting lengths of hoses together. However, due to the fact that the hoses may carry heated water and cleaning fluids, the fittings themselves can become quite hot, making the fittings difficult to grasp and actuate for connection and disconnection of the hoses.

### SUMMARY OF THE INVENTION

The insulating collar for quick release fittings of this invention provides a thermally insulating collar device for use with metallic fittings such as quick release fittings used in the carpet cleaning industry, among others, where use with hot liquids or steam can cause the metallic fittings to become uncomfortably (and even dangerously) hot. The inventive collar device is made from a thermally insulating material such as plastic, and is either formed over and around a fitting as manufactured, or designed as an aftermarket item to slip over an existing metallic fitting. Either embodiment enables manipulation of the movable portion of the quick release fitting in the traditional manner, while providing a thermally insulating layer of material over the metallic fitting to permit easy and comfortable actuation of the fitting, even when heated fluids are passing through the fitting.

The permanently installed embodiment of the inventive collar is preferably manufactured in the form of a hollow cylindrical body formed or molded over and completely around a metallic fitting, with one or more radially inward flanges around the collar's internal circumference, defining one or more grooves designed to engage the knurled gripping surfaces of the movable portion of the quick release fitting.

The slip-over embodiment of the inventive collar is preferably manufactured in the form of a hollow cylindrical body with a longitudinal cut or gap, enabling the collar to radially expand to be slipped over the existing metallic fitting and then be snapped into place. The slip-over device further preferably includes one or more radially inward flanges around its internal circumference, defining one or more grooves designed to slip over and engage the knurled gripping surfaces of the movable portion of the quick release fitting.

### BRIEF DESCRIPTION OF THE DRAWINGS

FIG. 1 is a side elevation view in partial cross-section of a permanently installed embodiment of the insulating collar of this invention as formed onto a typical quick release-type fitting;

FIG. 2 is a side elevation view of the permanently installed embodiment of the insulating collar of FIG. 1; and

FIG. 3 is a side elevation view of a slip-over embodiment of the insulating collar of this invention.

### DETAILED DESCRIPTION OF A PREFERRED EMBODIMENT

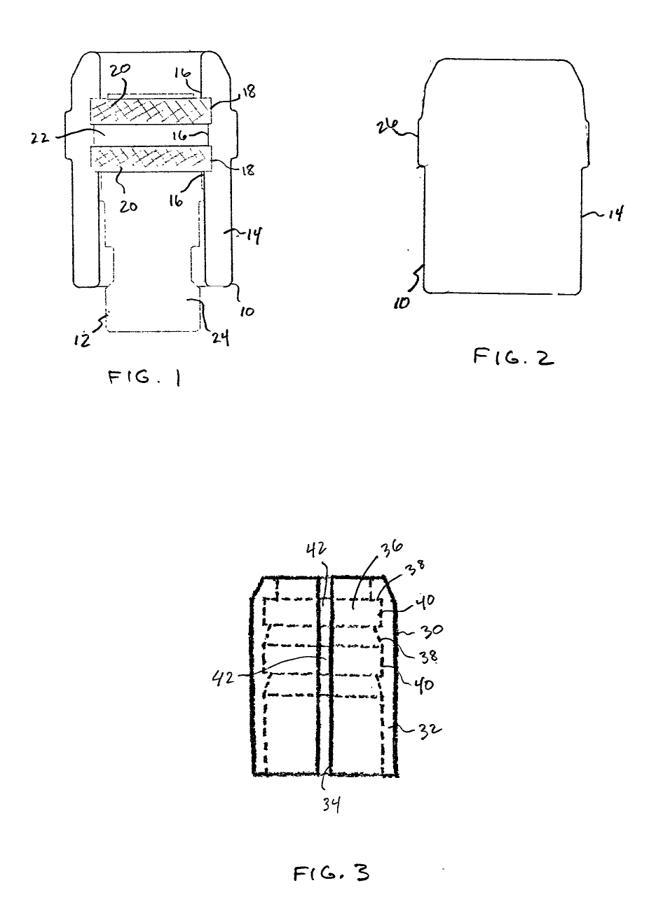

FIG. 1 is a side elevation view in partial cross-section of a permanently installed embodiment 10 of the insulating collar of this invention as formed onto a typical quick-release type fitting 12. The permanently installed collar 10 is in the form of a hollow cylindrical body 14 composed of thermally insulting material such as plastic formed or molded around the metallic fitting 12, with one or more radially inward flanges 16 around the collar's internal circumference, defining one or more grooves 18 designed to engage the knurled gripping surfaces 20 of the movable portion 22 of the quick release fitting 12. Thus, the movable portion 22 of the fitting may be moved longitudinally relative to the fixed portion 24 of the fitting to actuate the release function of the quick release fitting, as is well known in the art.

FIG. 2 is a side elevation view of the permanently installed embodiment 10 of the insulating collar of FIG. 1. Body 14 preferably includes radially outward flange 26 for improved gripping of the collar. The dimensions of the inventive collar may of course vary with the application, but with many typical fittings such as those used in the carpet cleaning industry, the collar may be approximately 2.219 inches in maximum length, 1.625 inches in maximum outside diameter, 1.14 inches in maximum internal diameter (to accommodate the knurled gripping surfaces on the movable portion of the fitting), and 0.998 inches in minimum internal diameter (to capture the knurled gripping surfaces on the movable portion of the fitting, and to clear the fixed portion of the fitting)

FIG. 3 is a side elevation view of a slip-over embodiment of the insulating collar of this invention. Slip-over collar 30 includes a hollow cylindrical body 32 with a longitudinal cut or gap 34, so that the collar may be radially expanded to slip over an existing quick-release fitting 36, and snapped into place over the fitting so that one or more radially inward flanges 38 around the internal circumference of the collar define one or more grooves 40 to engage the knurled gripping surfaces 42 of the quick-release fitting.

While this invention has been described in connection with preferred embodiments thereof, it is obvious that modifications and changes therein may be made by those skilled in the art to which it pertains without departing from the spirit and scope of the invention. Accordingly, the scope of this invention is to be limited only by the appended claims.

What is claimed as invention is:

1. A collar apparatus for a quick-release hose fitting, the fitting having a movable portion and a fixed portion, the movable portion having a gripping surface, said collar apparatus comprising:
a hollow cylindrical body portion composed of thermally insulating material, said body portion including at least one radially inward flange portion defining at least one groove adapted to engage the gripping surface of the movable portion of the fitting, and enabling movement of the movable portion relative to the fixed portion of the fitting.

2. The collar apparatus of claim 1 wherein said hollow cylindrical body portion is formed completely around the fitting.

3. The collar apparatus of claim 1 wherein said hollow cylindrical body portion includes a longitudinal gap to enable the collar to expand over and around an existing fitting.
